(19) United States
(12) Patent Application Publication
(10) Pub. No.: US 2021/0254467 A1
(43) Pub. Date: Aug. 19, 2021

(54) REGENERATIVE PUMP OR TURBINE WITH STATIONARY AXLE AND ROTATING HOUSING

(71) Applicant: Evangelos Kotriklas, Chalkida Evia (GR)

(72) Inventor: Evangelos Kotriklas, Chalkida Evia (GR)

(21) Appl. No.: 17/274,209

(22) PCT Filed: Sep. 10, 2019
(86) PCT No.: PCT/GR2019/000063

§ 371 Date: Mar. 8, 2021

(30) Foreign Application Priority Data
Sep. 11, 2018 (GR) 20180100416

(51) Int. Cl. F01D 1/12; B64D 27/10

(52) U.S. Cl. CPC F01D 1/12; B64D 27/10

(57) ABSTRACT

This invention is about a set of common features that will characterize any machine of the new type to be produced within the set of pumps, turbines and blowers. The machines in this new category, as will be here described, will be told apart from those already in use by one main peculiarity. They will feature a stationary (non-rotating) axle for the rotation of the impeller around it but the impeller will be a solid part of the housing which will be the rotating part. Firmly, on or through the hollow core of the axle, ducts will be fitted for the intake and discharge of the powering or pumped fluid. So the housing of the machine will deliver or receive power from the body in which it will be incorporated or connected (that is torque times angular velocity). An implementation of this invention is shown in the accompanying drawings. Here the rim of a wheel of an aircraft is the rotating body. Part of the rim will serve as the housing (containing shell) of an air-driven turbine (or pump as the case may be). Accordingly, the normal stationary hub of the (formerly idle) wheel will serve as the axle of rotation for the impeller born by the rotating housing. This turbine within the rim will be powered by compressed air from the fuselage to make torque for prespinning the wheel just before touchdown. During landing, this air may be redirected to the brakes for early cooling. The rim already transformed into an air-driven turbine can be utilized to taxi or pull-out the aircraft without a tractor. In this case the turbine of this invention can be made as a two-stage regenerative machine. Research on the capabilities of the just invented turbine at the phase of development will determine the feasibility of taxiing without the main engines at least partially, using pneumatic power from the Auxiliary Power Unit.

The type of engine to be made according to this description belongs to the set of pumps and turbines and precisely to the subset of them known as of side-channel or of the regenerative type. The innovations through which a new type within this subset will be produced are the object of the main claim. Devices of regenerative, also known as side-channel type, normally used in industry, appear in either function as pumps or turbines according to the origin and destination of the power in use. That is, when they receive torque-times-angular-speed to produce pressure-times-flow, they are termed pumps. But in the opposite manner they are termed turbines. In either case mechanical work passes from one form to the other or vice versa. The same machine may work symmetrically in either identity and with the same efficiency and with no directional bias. This is due to its geometrical symmetry. Owing to this adaptability, these devices are popular for a variety of low power tasks. But for more power-consuming service, centrifugal machines are preferred for their higher efficiency. Blowers, as opposed to compressors, are rotational pumps of gasses producing a high flow with a low pressure.

Owing to an inferior efficiency in comparison to other competitive devices, side-channel machines may work as turbines until now only in theory. This invention aims at making turbines for special applications by exploiting the side-channel principles comprising the advantage of non-directional bias. To produce the new type of turbine out of the standard pump, a mutual change is made between rotational and stationary parts. The main claim presents the accompanying provisions and details that enable this change.

In every normal rotational hydraulic or pneumatic machine, a subset of the composing parts rotates around a geometrical axis which is the centerline of a materialized axle. The rotating subset comprises this axle together with any part firmly attached to it, that is an impeller immersed in the fluid within a stationary housing and a piece for power transmission at the visible end of the axle, usually a pulley or a coupler.

To meet requirements for specific end uses, a mutual change is made between stationary and rotating parts of a regenerative machine at the designing of a more suitable new type. Accordingly, the axle will be kept stationary and the housing will rotate around it. This rotating housing will be connected directly to the object of the end use or even merge with it. The main claim shows the characteristics that differentiate the proposed new type of pumps or turbines from the standard configuration of well known regenerative or side-channel pumps.

In the most promising example of such a case, the end use object will be a wheel in the landing gear of an airplane. The rim of the wheel will serve as part of the housing of an air-driven turbine. The wheel will be set in motion by the counter-toque generated against the torque delivered to the stationary axle. Pressurized air for the turbine will be provided by an existing power source in the fuselage. Just after touchdown the wheel will be rotated by the relative motion of the runway to make an air blower out of the turbine within the rim providing a flow for cooling the brakes.

In this manner existing parts of the wheel (rim and axle that is the hub) contribute in the shaping of the powering mechanism. Physics involved in this function explain why the effects we find in the new configuration are identical to those in the old one. The standard concept of a rotating wheel around a stationary hub will best fit the geometrical properties of the proposed pump or turbine with rotating housing and stationary axle. This will produce a self-propelled wheel incorporating the powering turbine within the rim and exploiting the rim for housing the turbine.

Turning the inside out at the design of a mechanism will be new in our case of regenerative devices, but as a general concept it has been implemented in different engines in the last century. Iconic to this have been the rotary engines of some early biplanes. In these a radial pack of internal combustion cylinders was made to rotate around a stationary crankshaft protruding from the fuselage. On the rotating pack of cylinders the propeller was attached and the entire motor also worked as an oversize flywheel. The short career of this type of engine contributed to the fame of the “Sopwith Camel” fighter.

A modern and widespread example of rotational motor in which the axle is stationary and non-rotating and the housing rotates around it, can be observed in a set of industrial electric fans as well as in ceiling-mounted fans that provide a cooling breeze for people in buildings. Analogically such an inverse configuration will be made at the design of side-channel machines to produce a sub-set of them most fit for special tasks, mainly in the sense of turbines.

Examples like those already mentioned highlight the time-proven idea of mutually changing rotating for stationary, non rotating parts in torque-generating machines. That is why this idea in itself is not a claim. The main claim is about how to do it for side-channel or regenerative pumps or turbines, so as to use them in this reversed configuration for special implementations.

There is no theoretical obstacle in making turbines that work by the “regenerative” or “side-channel” principle and the practical means to do it are given in the main claim. New end uses call for the development of the reverse configuration in such a type of turbines. They may also double as pumps with the same efficiency.

The function of side-channel pumps has no preference of direction in the flow of the fluid. It follows the rotational direction of the motor. Moreover in the presence of a gas interrupting the flow, the suction of a liquid is self-primed. This makes them popular in less demanding uses in terms of efficiency, for up to 10 kw power, against other more efficient types for high power-consuming services. Giving or taking power from a regenerative device follows, respectively, a negative or positive slip in the flow against blades, the former for a turbine and the latter for a pump.

A usual impeller in regenerative pumps is made of a circular array of plane paddles, also termed as blades or vanes, protruding in a starlike manner from the circumference of a solid core in the form of a disc normal to the axle with which it rotates. Each blade is attached normal to the disc so as to materialize a meridian plane in this axially symmetric body.

It will be the geometrical peculiarity of such a pump or turbine with inverse configuration compared to existing ones, as shown in claim 1 that will make it fit for some specific end uses. Gains in volume, weight and costs in production and maintenance are expected to be obtained by this innovation.

A description of the new product may be best seen as a transformation, step by step, of an existing side-channel device. The total set of changing steps will compose the main claim.

### STEP 1. CHANGING THE HOUSING

To make the housing capable of rotating, all parts that cancel its axial symmetry must be removed. These are.
A). An external base. The device will be supported internally by the stationary, non-rotating axle of rotation which will be fixed rigidly by its visible end.
B). Ducts carrying the fluid in and out through two outlets (intake and discharge) on the circumference of the housing. These two outlets are the starting and ending points of the side-channel at 20 to 30 degrees apart. Between them the cross-section of the housing is diminished because the volume of the diverted side-channel is missing.
C). The sector between the two outlets. Along this, the cross-section of the housing becomes as narrow as to impede the passage of the useful volume of fluid in an endless circular manner, so that it is redirected to the discharge outlet. Through the remaining cross-section area only the blades of the impeller may pass with just the needed narrow margins (gaps). The function of this area with the narrow sector flanked by the outlets will be transferred to a proper detail on the circumference of a non-rotating inner body.

### STEP 2. SWAPPING IMPELLER AND SIDE CHANNELS

In any of the regenerative machines following the up-to-date art, the blades of the impeller rotate by narrow margins within a virtual shape flanked by two side-channels. According to this invention, shape and position of the impeller will both be changed. The impeller is removed from the body of the axle, which will be then the core of the non-rotating set of parts. It will be rebuilt in two halves on the faces of the rotating housing with blades planted radially on them.

The vacant place of the relocated impeller will be then occupied by a non-rotating part (attached around the stationary axle) that has roughly the outer shape of the previous impeller disc. This part will be hollow as a drum but with an axial core in the shape of a profiled sleeve for non-rotational connection with the axle. The space between the faces of this drum serves for the passage of the working fluid towards the new channel that replaces the old two-piece side-channel, and may be called working-channel or inner-channel in this configuration. The fluid passes only once along the entire length of the working channel, somewhat less than a full circle and then enters again the drum to reach the exit through a separate path within it. The cylindrical surface of the drum borders the working channel. The working channel plus a smaller stationary body containing the new inlet and outlet at the extremities, occupy the volume which the previous array of blades used to sweep through. To form an impeller in the other location, plane blades are planted radially on both the concave inner faces of the outmost area of the housing. The outline of each blade is limited by the half cross-section of the housing into which it is nested. The blades divide each of the two mirrored volumes of the new impeller into a polar array of compartments open on the sides of the working channel. The inner faces of the nearly toroidal outmost area of the housing are now the bearing body of the impeller.

The two halves of the new impeller flank the inner channel to make it bordered by the sweeping free edges of the blades. Fluid, moving in the inner channel, exchanges forces with the blades in the same manner as it did with former side-channels. So the term “working channel” may be accepted to identify it in the following text.

An imaginary viewer travelling along a border of the working channel on the impeller will see the channel narrowly swept by the (really stationary) feeding sector, contactless to the blades with a small tolerance. Two orifices facing the ends of the channel, are seen as the limiting faces of this sector. The predecessor of this sector was the out-of-circular-symmetry area on the stationary housing in the scheme of origin. Now this “feeding sector” is protruding from the cylindrical outer surface of the drum into the channel, blocking, with just an essential tolerance, the entire cross-section of the channel. It represents an irregularity on a small portion of the full circle leaving the rest to be the working length of the channel on its circular centerline. This is the complete composition of the working channel. The working channel is now an one-piece item that takes the function of the pair of side-channels which were present in the typical regenerative machine.

### STEP 3. A SPECIAL AMELIORATION OF THE IMPELLER

The basic scheme of the new impeller already described may now be further worked upon by an adjustment peculiar to the new product. One half of the impeller mirroring the other on the plane of rotation will be relocated by rotation around the axis as much as half a pitch in respect to the other half-impeller. Here a pitch is the angle between two consecutive blades. Accordingly, the free edge of each blade, in one half-impeller, points to the middle of the space between two blades in the other. This last reshaping of the impeller will make the fluid pass by the blades in a snakelike manner, meandering along the working channel. This movement will be combined with the cross-sectional vortices that enable the function of any side-channel machine. Offsetting, instead of mirroring, the blades that flank the working channel, is expected to make the machine work with less slip, leading to gains in efficiency.

### STEP 4. DUCTS TO CARRY THE FLUID IN AND OUT OF THE WORKING CHANNEL

The stationary drum is segmented internally by meridian walls into compartments, two or more of them, depending on the itineraries of the fluid we want to lead through, as needed for one-stage or two-stage devices. These non-rotating compartments serve as ducts leading to and from the extremities of the working channel. The innermost border of the working channel is the cylindrical surface of the drum. Fluid enters the channel moving outwards in one compartment of the drum, flows along the entire length of the channel, something less than a full circle, and upon leaving it, enters another compartment adjacent to the former, moving inwards on the way to exit the turbine. The compartments of the drum are connected to the environment of the machine by two ducts for entry and exit, adjacent and parallel to the non-rotating axle. These two ducts pass through a local radial extension of the stationary axle so as not to interfere with the housing which rotates almost in contact with the extension except for an essential gap. Alternatively the ducts may pass through a hollow hub that is the non-rotating axle.

The drawings that accompany this description show an example incorporating the device here described. It is a wheel of an aircraft. An air-driven turbine shaped within the rim which serves as the turbine's housing, develops torque to rotate it. Just after touchdown the turbine functions as a blower generating a flow that can be led into the brakes system to assist cooling. Here follows the list of drawings.

Plate 1.

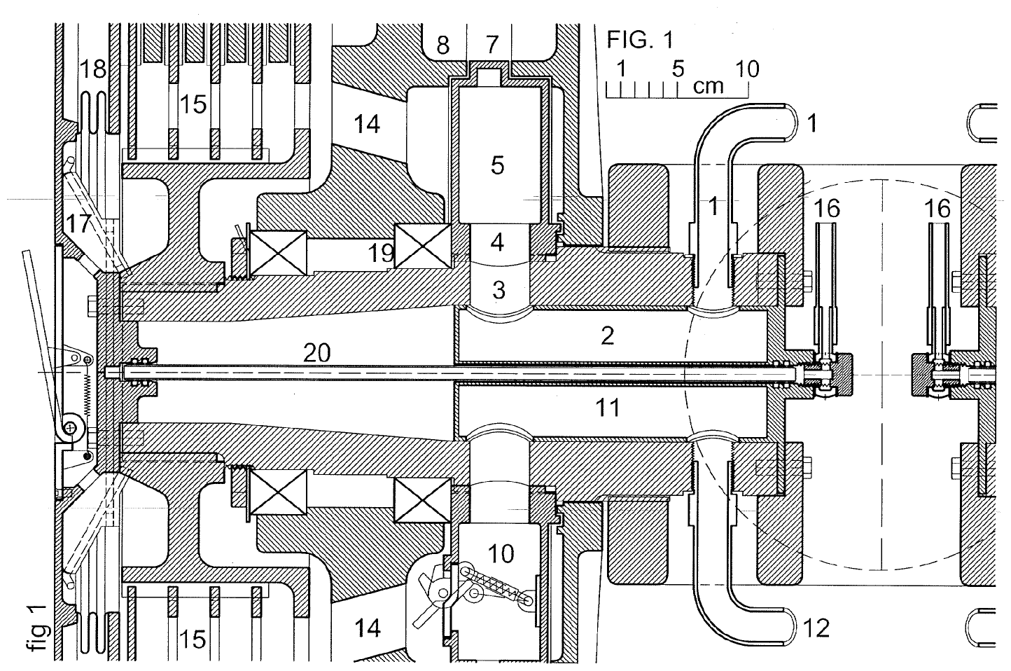

FIG. 1. Horizontal section through the hub of a wheel for an aircraft (an innermost portion) by a meridian plane (1)(2)(3)(4). Path of incoming air. (5) Compartment in the drum leading air into the working channel. (7) Working channel. (8) Blade of the impeller. (10) Compartment in the drum discharging air from the channel and a valve to redirect it towards the braking system. (11)(12) Exit path to discharge air. (14) Perforations for air to enter the braking system. (15) Braking system. (16)(17)(20) Hydraulic or pneumatic system activating the braking elements. (19) bearing. (18) Bellows pressing on the discs of the braking system

Plate 2.

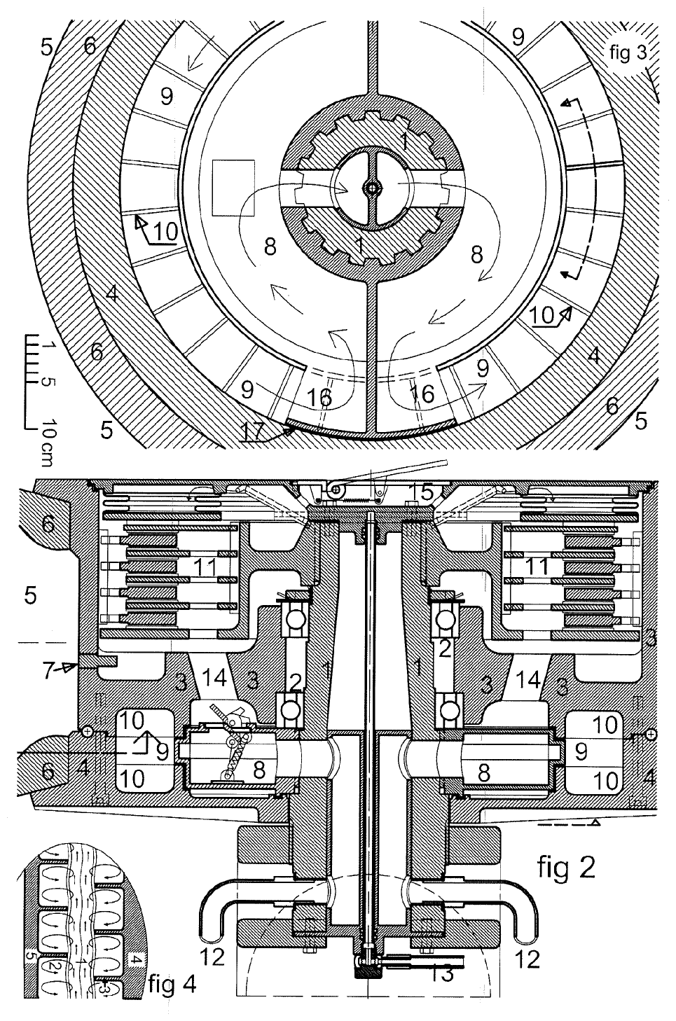

FIG. 2. Same as in FIG. 1 but larger area. (1) Non-rotating hub that is the axle of rotation for the housing. (2) Bearings. (3) Innermost part of the rim. (4) Add-on, (detachable) inboard ring of the rim with extension towards the hub. (5) Tyre inner space. (6) Tyre wall. (7) Overpressure relieve valve. (8) The drum. (9) Working channel. (10) Blade of the impeller. (11) Braking system. (12) Ducts feeding or expelling air. (13) Ducts for the braking system. (14) Opening for air to pass towards the braking system. (15) Valve to discharge air in the atmosphere.

FIG. 3. Vertical section, normal to the hub by the plane of the centerline of the working channel. (1) The hub. (4) Detachable ring of the rim. (5) Tyre inner space. (6) Tyre, innermost extremity. (8) The drum. (9) Working channel. (10) Blade of the impeller. (16) Outlet from the drum and inlet to the drum, that is, the starting and the ending points of the working channel. (17) Gap between the stationary block of the said orifices and the rotating rim.

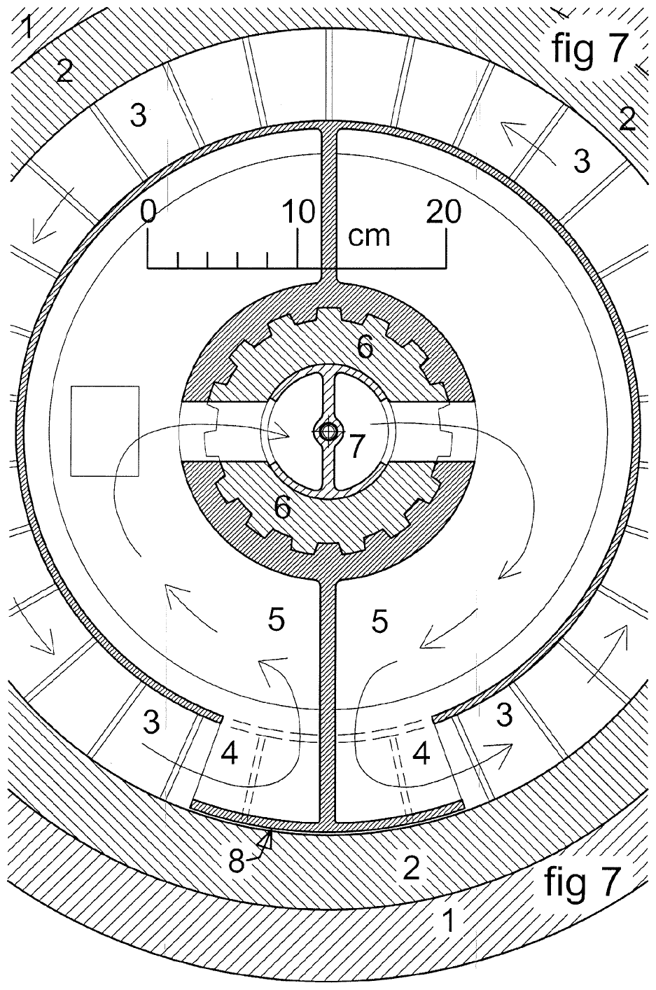

FIG. 4. (Same as FIG. 6 in Plate 3). (1) Working channel. (2) Inter-blade space in the impeller. (3) Blade of the impeller. (4) Main part of the rim. (5) Detachable part of the rim.

Plate 3.

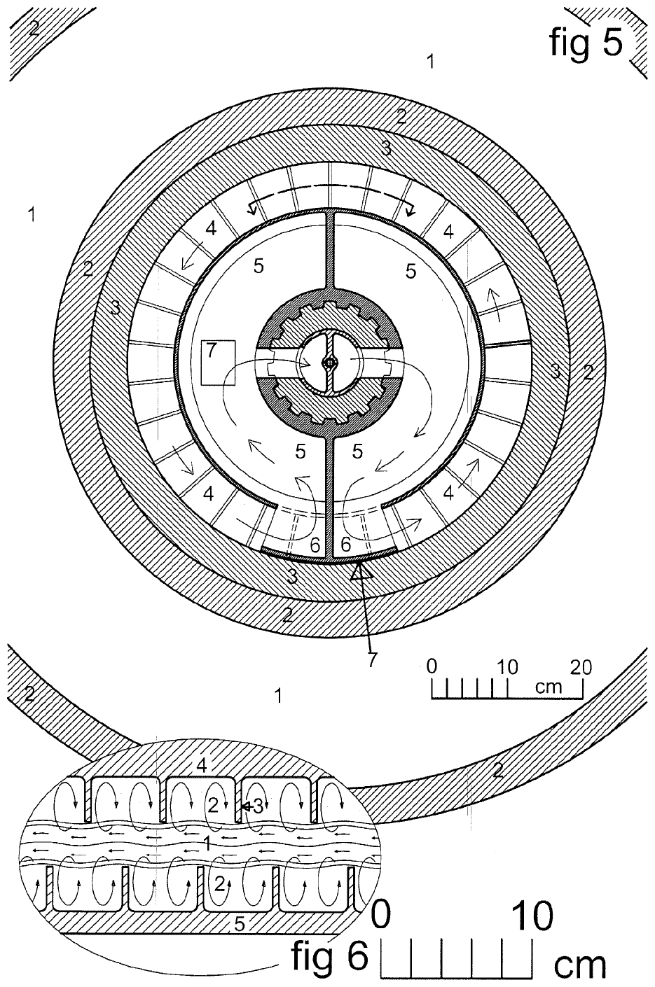

FIG. 5. Area of which FIG. 3 of Plate 2 is a detail. Section normal to the hub by a plane containing the centerline of the working channel. (1) Inner space of the tyre. (2) The tyre. (3) The rim. (4) the working channel. (5) The drum. (6) Orifices at the extremities of the working channel. (7) Gap.

FIG. 6. (Same as FIG. 4 of Plate 2). (1) Working channel. (2) Inter-blade space at the impeller. (3) Blades of the impeller. (4) Main part of the rim. (5) Detachable part of the rim.

Plate 4.

FIG. 7. Detail of the section by the plane of the centerline of the working channel. (Same as FIG. 3 of Plate 2 and FIG. 5 of plate 3). (1) Tyre. (2) Rim. (3) working channel. (4) Orifices. (5) drum. (6) Hub. (8) Gap.

Plate 5.

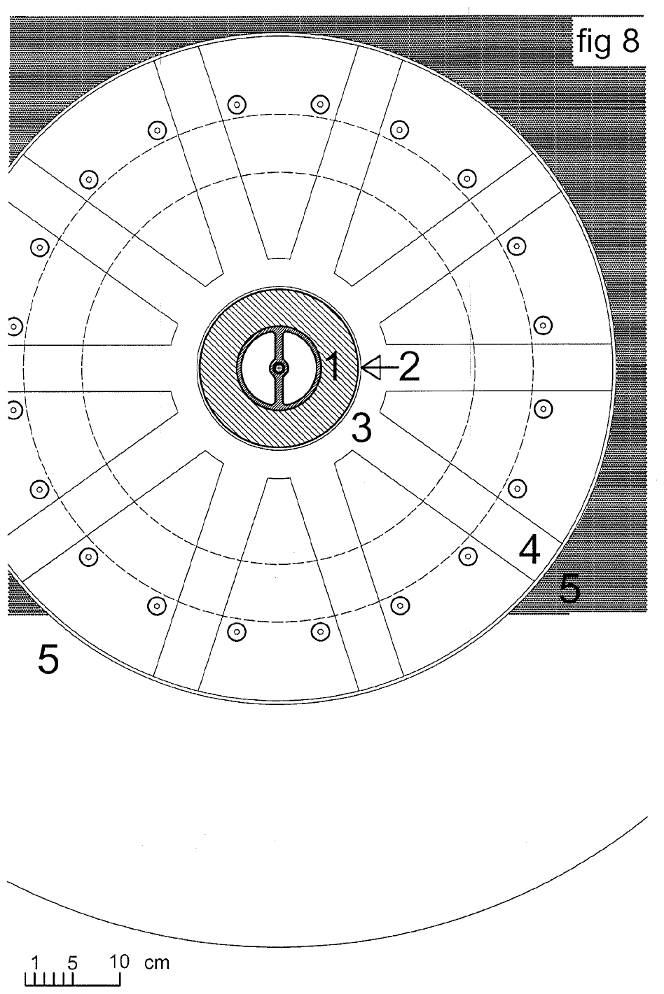

FIG. 8. Section normal to the hub and elevation of the detachable part of the rim. (1) The Hub. (2) A gap. (3) Detachable part of the rim. (4) Retaining ring for the tyre in the detachable part. (5) Elevation of the tyre.

Plate 6.

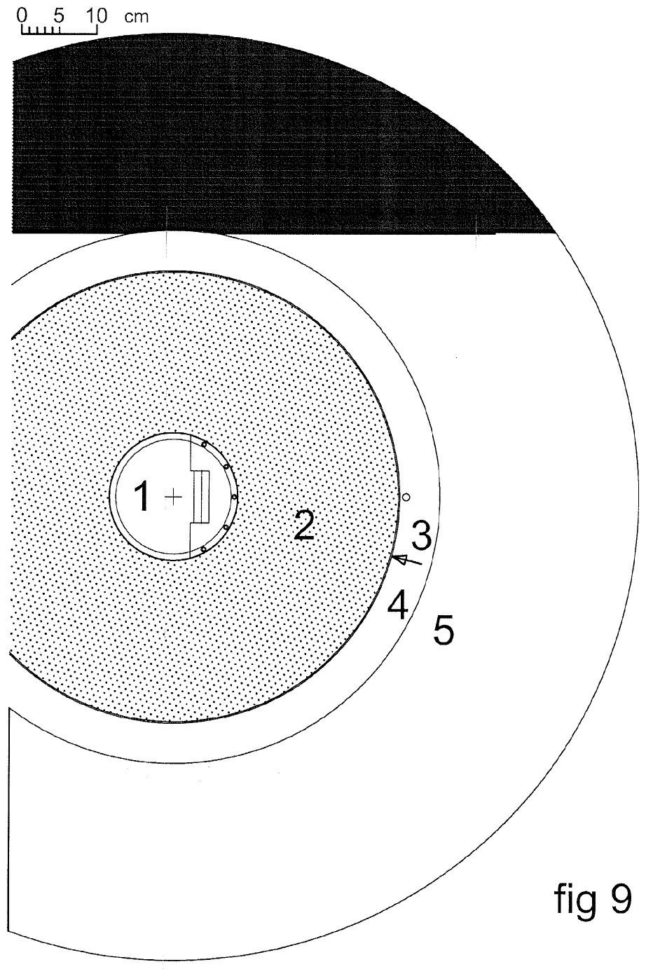

FIG. 9. Elevation of the wheel. (1) Discharge valve for air from the brake system. (2) Stationary (non-rotating) cover. (3) A gap. (4) Main body of the rim. (5) The tyre.

Plate 7.

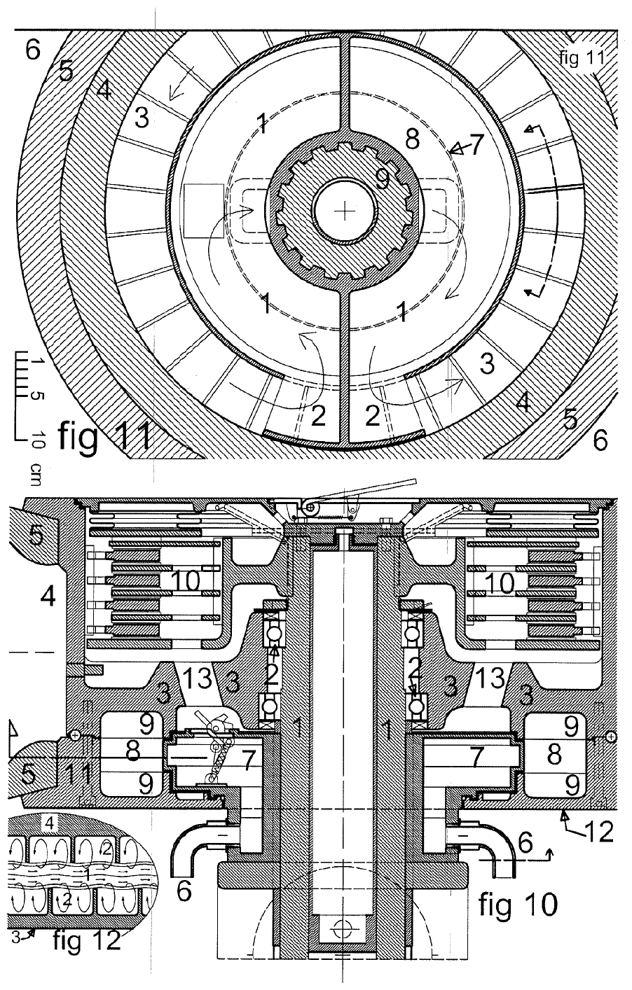

FIG. 10. An alternative design corresponding to the one shown in FIG. 1 of Plate 1. (1) A common hub (one-piece) for a pair of wheels. (2) Bearings. (3) Rim. (4) Inner space of the Tyre. (5) Tyre. (6) Duct leading the working air in or out. (7) Drum. (8) Working channel. (9) Inter-blade space at the impeller. (10) Breaking system. (11) Detachable part of the rim extended to cover its inboard face. (12) The extension of the detachable part.

FIG. 11. Section normal to the hub by the plane of the centerline of the working channel. (1) Drum. (2) Orifices. (3) Working channel. (4) Rim. (5) Tyre. (6) internal space of the tyre. (7) Projection of the gap between the stationary and rotating parts. (8) Projection of an extension of the hub through which ducts pass.

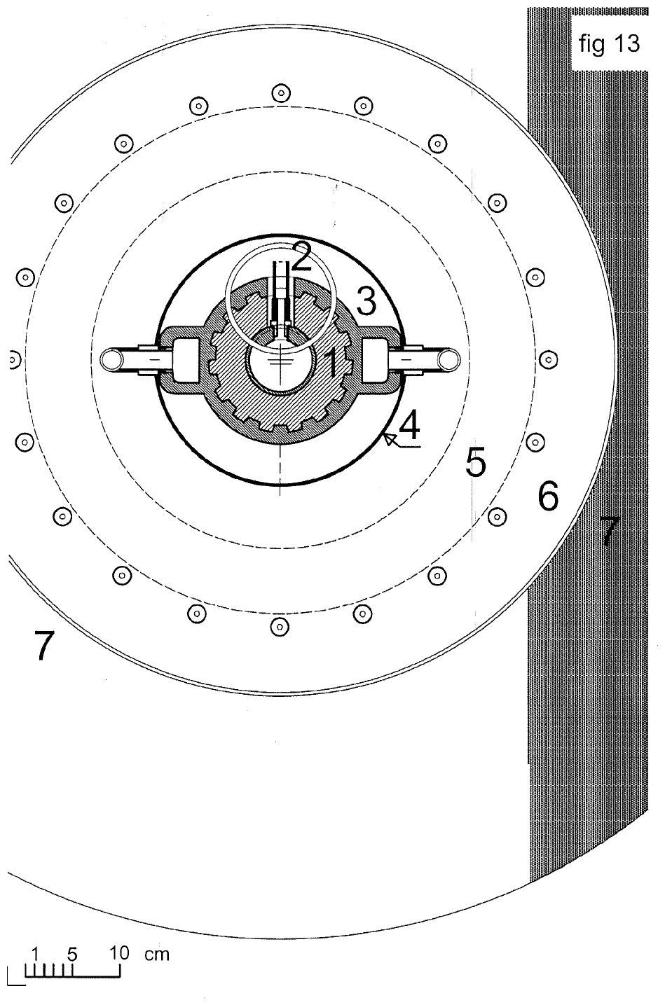

FIG. 12. Developed cylindrical section on the blades. (1) Working channel. (2) Inter-blade space. (3). Detachable part of the rim. (4) Main part of the rim.

Plate 8.

FIG. 13. Section normal to the hub with elevation of the inboard face of the wheel according to the variation shown in Plate 7. (1) Hub. (2) A duct controlling the braking system. (3) Non-rotating area for ducts to pass through. (4) Gap between the former area and the face of the rim. (5) Detachable face of the rim. (6) Outmost area of the inboard face of the rim holding the tyre in place. (7) Elevation of the tyre.

Plate 9.

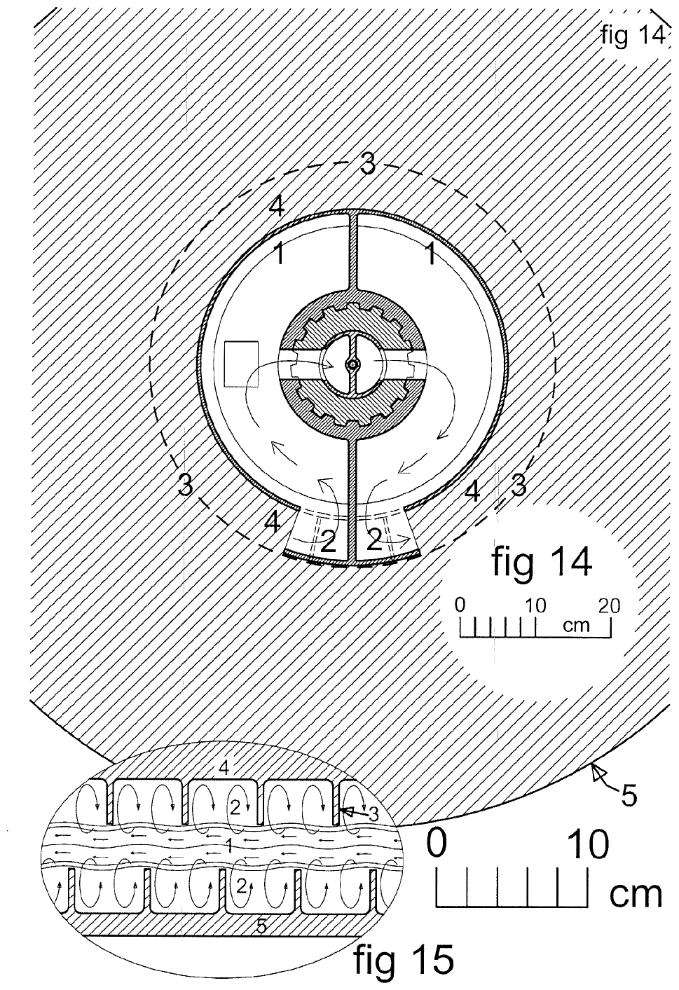

FIG. 14. Additional information related to Plate 3. (1) and (2) Non-rotating parts. (1) The drum. (2) Orifices at the extremities of the working channel. (3) Rotating parts. (4) Working channel zone. (5) Rolling surface of the wheel.

FIG. 15. Development of a section along the centerline of the working channel. (1) The Working channel. (2) Inter-blade areas of the impeller. (3) Blades. (4) Main part of the rim. (5) Detachable part of the rim.

Plate 10.

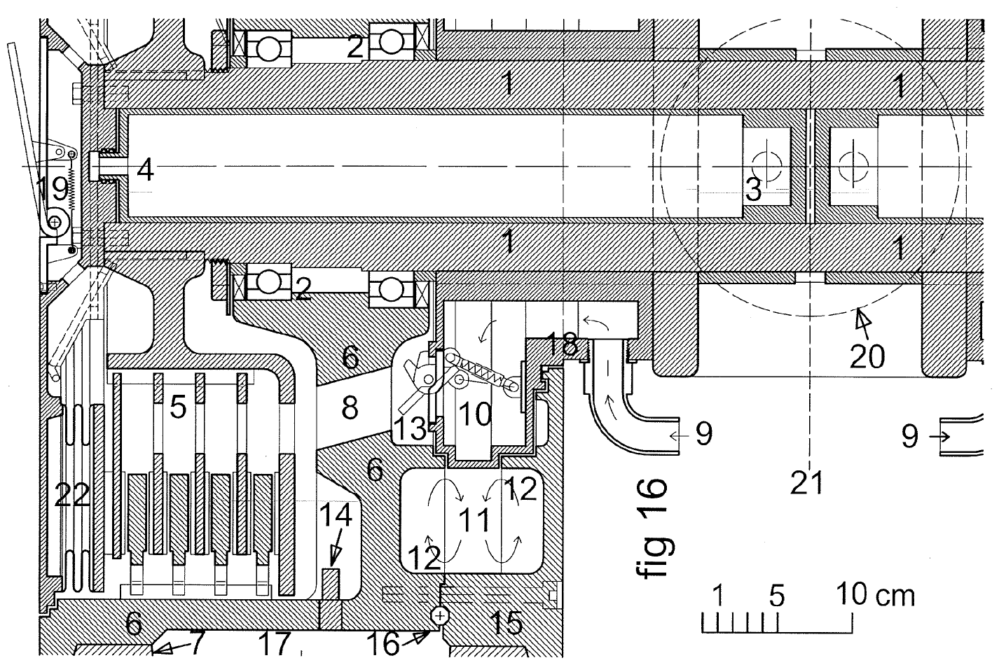

FIG. 16. Detail of FIG. 8 on Plate 7. (1) Hub. (2) Bearings. (3) and (4) Ducts for the brakes. (5) Braking system. (6) Main part of the rim. (7) Tyre. (8) Opening to let air through the braking system. (9) Ducts feeding pressurized air or discharging air. (10) Drum. (11) Working channel. (12) Inter-blade space at the impeller. (13) Valve to let air into the brakes. (14) Safety valve against overpressure. (15) Detachable part of the rim. (16) O-ring against leaking. (17) Internal space of the tyre. (18) A non-rotating “navel” centered around the hub. (19) Discharge valve of cooling air from the brakes. (20) Projection of the column connecting wheel assembly to fuselage. (21) Mirroring plane of the pair of wheels.

1. According to this invention a new subset of machines is produced that can be classified as pumps, turbines and blowers in the well-known set of regenerative aka side-channel machines. The overall difference that will tell apart the members of this subset from the machines that are made by the up-to-date art is an innovative design as follows. It materializes a mutual change (swap) of rotational for stationary members (parts) of these machines. That is, the impeller will rotate together with the housing while the axis for the rotation will be a stationary (non-rotating) axle. Products by the new design will be best fit for out-of-the-way uses as the one stated in the second claim. An analysis of this difference in the design of a side-channel aka regenerative machine of the new type as compared to the usual one is given below. It consists of the following items.
1.1 The housing is constructed as a perfectly self-symmetrical object in reference to the axis of rotation, which is the centerline of a materialized stationary (non-rotating) axle.
1.2 The new impeller (in the function of the sun-like old one) will be a twin formation of radially arranged plane blades (vanes) incorporated at the inner faces of the housing, mirroring each other on a plane of symmetry normal to the axle.
1.3 The position of the blades (vanes) in one half-impeller is now made offset by half a pitch that is half the angle between two consecutive blades. By this re-arrangement the plane of each blade bisects the space between two blades of the opposite half-impeller. This feature will induce a snakelike movement to the powering fluid combined with the vortices that make the device work as a regenerative one.
1.4 The place of each of the former side-channels is now occupied by a half-impeller. That is why a new position is reserved for the current substitute of the deleted side-channels in the vacant 3d-shape which used to be swept by the blades of the former impeller. This shape now contains the unique “inner channel” in the function of the two typical side-channels of a usual regenerative machine. This “inner channel” has been termed a “working channel” in the pertinent description.
1.5 The vacant place of the bearing disc of the ex-impeller is now filled by a stationary (non-rotating) hollow body, approximately a shallow drum. This forms an extension of the stationary axle to which it is attached concentrically by a profiled hollow core.
1.6 The cylindrical outmost surface of the drum borders the “working channel”. This is the vacant space which used to be swept by the vanes of the previous impeller. Its centerline is an arc of about 160 degrees. The rest of it on the full circle is filled by a shape that extends out of the drum into the entire cross-section of the working channel. This shape contains two back-to-back orifices that stand at the starting and the ending points of the working channel.
1.7 The stationary drum is divided into compartments that provide two separate paths for the powering fluid to move in and out of the working channel. The paths continue through a cavity along the centerline of the axle or pass closely by the axle through a body concentric to it so as not to interfere with the rotating housing.

2. In any of the wheels that bear the weight of an aircraft on the ground the rim is utilized so as to incorporate the housing of an air-driven turbine capable of working also as a blower of the type described in claim 1. Compressed air from the Auxiliary Power Unit is led into the turbine to produce a torque for pre-spinning the wheel just prior to touchdown. Immediately next, a flow originating from the turbine will be inserted to the braking system for cooling. By producing torque this way with pneumatic means within the wheels, taxiing will be assigned to the self-powered wheels without help from the main engines. Autonomy will also be provided for pushback based on the symmetrical properties of the turbine as described in claim 1. The substitution of the main engines on the ground by this pneumatic system will provide, apart from economical also environmental benefits for aviation.
